(19) United States
(12) Patent Application Publication
(10) Pub. No.: US 2011/0213529 A1
(43) Pub. Date: Sep. 1, 2011

(54) SYSTEM AND METHOD FOR DETERMING A POSITION ON AN IMPLEMENT RELATIVE TO A REFERENCE POSITION ON A MACHINE

(75) Inventors: Steven R. Krause, Chillicothe, IL (US); Ryan A. Kingdon, Peoria, IL (US); Eric J. Dishman, Peoria, IL (US)

(73) Assignee: Caterpillar Inc., Peoria, IL (US)

(21) Appl. No.: 12/713,661

(22) Filed: Feb. 26, 2010

(51) Int. Cl. G06F 7/00; G01C 21/00

(52) U.S. Cl. 701/50; 701/213

(57) ABSTRACT

The disclosure describes, in one aspect, a method for determining a position on a machine relative to a reference position on the machine. The method includes determining the reference position in a coordinate system, determining a first desired position on the machine in the coordinate system, and determining the first desired position relative to the reference position. The method further includes updating a control system using the first relative desired position.

### TECHNICAL FIELD

This patent disclosure relates generally to an implement control system, and more particularly to systems and methods for determining a position on an implement relative to a reference position on a machine.

### BACKGROUND

Earthmoving machines such as track type tractors, motor graders, scrapers, and/or backhoe loaders, have an implement such as a dozer blade or bucket, which is used on a worksite in order to alter a geography or terrain of a section of earth. The implement may be controlled by an operator or by a control system to perform work on the worksite such as achieving a final surface contour or a final grade on the worksite. Positioning the implement, however, is a complex and time-consuming task that requires expert skill and diligence if the operator is controlling the movement. Thus, it is often desirable to provide autonomous control of the implement to simplify operator control.

To control the implement autonomously, it is sometimes necessary to determine the accurate position of at least one point on the implement relative to a reference point on the machine. It is also sometimes necessary to determine the precise distance between at least one point on the implement and a reference point on the machine. Determining the accurate relative position and precise relative distance of a point on the implement and a reference point on the machine may require calibrating or updating an implement control system using the position and distance information.

Prior art systems acquire position and distance information using straight edges, tape measures, plum bobs, and other manual methods. And some prior art systems update implement control systems using position information relative to reference points located extrinsic or external to the machine, such as, for example trees, rocks, flags, and other such markers. For example, U.S. Pat. No. 6,418,364 to Kalafut et al. (“Kalafut”) discloses a method for determining a position and a heading of a work machine having a work implement controllably attached. Kalafut discloses that a reference point is used to provide a reference for a position and a heading of the work machine. Examples of suitable reference points include “rocks, flags, markers, trees, and the like.”

Nevertheless, because the disclosed methods are subject to a variety of human errors that are difficult to detect during the measurement process, Kalafut and other prior art systems disclose methods that are satisfactory when the measurement distances are not large. In addition, the disclosed methods and prior art systems include measurement processes that may require two or more individuals, a reference point that is fixed and constant relative to a known coordinate system (i.e. the reference point's coordinates do not change), and/or a reference point that is external to the machine, which may require repeated calibration of the machine relative to the external reference point and can also become very time consuming.

The disclosed systems and methods are directed to overcoming one or more of the problems set forth above.

### SUMMARY

In one aspect, the disclosure describes, a method for determining a position on a machine relative to a reference position on the machine. The method includes determining the reference position in a coordinate system, determining a first desired position on the machine in the coordinate system, and determining the first desired position relative to the reference position. The method further includes updating a control system using the first relative desired position.

The disclosure describes, in another aspect, an implement control system in a machine for determining a position on the machine relative to a reference position on the machine having an implement operatively connected to a rigid body of the machine. The control system includes a controller operatively connected to the implement. The controller is adapted to determine the reference position in a coordinate system, determine a first desired position on the implement in the coordinate system, determine a first relative desired position in which the first desired position relative to the reference position, and update the implement control system using the first relative desired position.

### BRIEF DESCRIPTION OF THE DRAWING(S)

FIG. 1 illustrates a side view of a machine having an implement control system in accordance with an exemplary embodiment of the present disclosure.

FIG. 2 illustrates a front view of a machine having an implement control system in accordance with an exemplary embodiment of the present disclosure.

FIG. 3 illustrates an implement control system in accordance with an exemplary embodiment of the present disclosure.

FIG. 4 is a flow diagram illustrating one embodiment of an implement control process in accordance with an exemplary embodiment of the present disclosure.

FIG. 5 is a flow diagram illustrating an alternative embodiment of an implement control process in accordance with an exemplary embodiment of the present disclosure.

### DETAILED DESCRIPTION

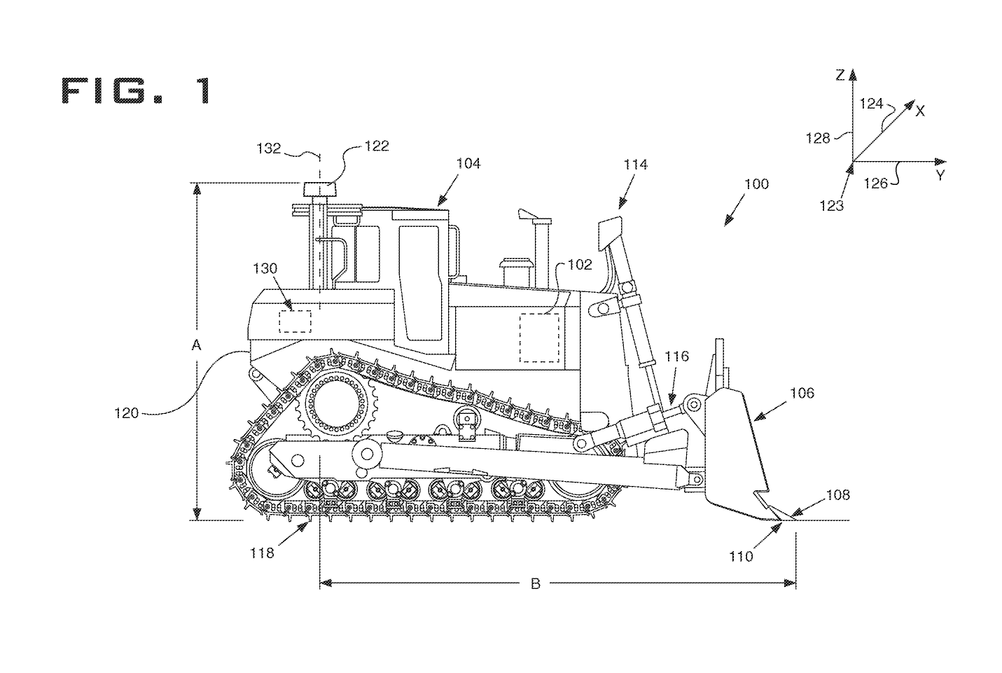

This disclosure relates to systems and methods for determining a position on an implement relative to a reference position on a machine. An exemplary embodiment of a machine 100 is shown schematically in FIG. 1. The machine 100 may be a mobile machine that performs some type of operation associated with an industry such as mining, construction, farming, transportation, or any other industry known in the art. For example, the machine 100 may be a tractor or dozer, as depicted in FIG. 1, a scraper, or any other machine known in the art. While the following detailed description of an exemplary embodiment describes the invention in connection with a dozer, it should be appreciated that the description applies equally to the use of the invention in other such machines.

In an illustrated embodiment, the machine 100 includes a power source 102, an operator's station or cab 104 containing controls necessary to operate the machine 100, such as, for example, one or more input devices for propelling the machine 100 and/or controlling other machine components. The machine 100 further includes an implement 106, such as, for example, a blade, a bowl, a ripper, or a bucket for moving earth. The one or more input devices may include one or more joysticks disposed within the cab 104 and may be adapted to receive input from an operator indicative of a desired movement of the implement 106. The cab 104 may also include a user interface having a display for conveying information to the operator and may include a keyboard, touch screen, or any suitable mechanism for receiving input from the operator to control and/or operate the machine 100, the implement 106, and/or the other machine components.

The implement 106 may be adapted to engage, penetrate, or cut the surface of a worksite and may be further adapted to move the earth to accomplish a predetermined task. The worksite may include, for example, a mine site, a landfill, a quarry, a construction site, or any other type of worksite. Moving the earth may be associated with altering the geography at the worksite and may include, for example, a grading operation, a scraping operation, a leveling operation, a bulk material removal operation, or any other type of geography altering operation at the worksite.

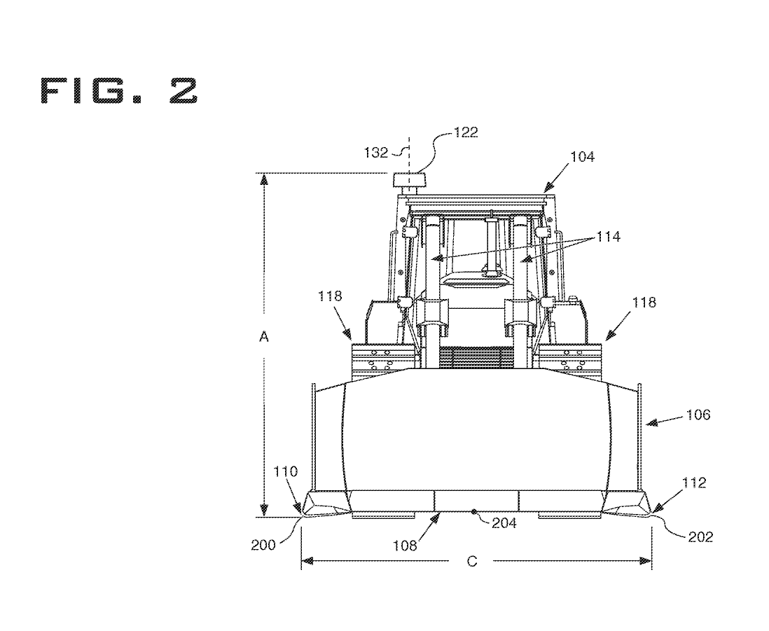

In the illustrated embodiment, the implement 106 includes a cutting edge 108 that extends between a first end 110 and a second end 112 (best shown in FIG. 2). The first end 110 of the cutting edge 108 of the implement 106 may represent or define a right tip or right edge of the implement 106 and the second end 112 of the cutting edge 108 of the implement 106 may represent or define a left tip or left edge of the implement 106. The implement 106 may be moveable by one or more hydraulic mechanisms operatively connected to the input device in the cab 104.

The hydraulic mechanisms may include one or more hydraulic lift actuators 114 and one or more hydraulic tilt actuators 116 for moving the implement 106 in various positions, such as, for example, lifting the implement 106 up or lowering the implement 106 down, tilting the implement 106 left or right, or pitching the implement 106 forward or backward. In the illustrated embodiment, the machine 100 includes one hydraulic lift actuator 114 and one hydraulic tilt actuator 116 on each side of the implement 106. The illustrated embodiment shows two hydraulic lift actuators 114 (as shown in FIG. 2), but only one of the two hydraulic tilt actuators 116 is shown (only one side shown).

The power source 102 is an engine that provides power to a ground engaging mechanism 118 adapted to support, steer, and propel the machine 100. The power source 102 may embody an engine such as, for example, a diesel engine, a gasoline engine, a gaseous fuel-powered engine, or any other type of combustion engine known in the art. It is contemplated that the power source 102 may alternatively embody a non-combustion source of power (not shown) such as, for example, a fuel cell, a power storage device, or another suitable source of power. The power source 102 may produce a mechanical or electrical power output that may be converted to hydraulic power for providing power to the machine 100, the implement 106, and to other machine 100 components.

The machine 100 further includes a frame or rigid body 120 disposed between the implement 106 and the ground engaging mechanisms 118. A position determining system 122 adapted to receive and process position data or signals may be mounted to the rigid body 120 of the machine 100. The position determining device 122 may be a global position satellite (GPS) system receiver. The GPS receiver, as is well known in the art, receives signals from a plurality of satellites and responsively determines a position of the receiver in a coordinate system 123 relative to the worksite, that is, in a site coordinate system. The site coordinate system 123 may be a Cartesian system having an x-coordinate 124, a y-coordinate 126, and a z-coordinate 128. In alternative embodiments, the position determining system 122 may include other types of positioning systems without departing from the scope of this disclosure, such as, for example, laser referencing systems.

The machine 100 further includes an implement control system 130 operatively connected to the input device and to the hydraulic actuators 114, 116 for controlling movement of the implement 106. The control system 130 may direct the implement 106 to move to a predetermined or target position in response to an operators' desired movement of the implement 106 for engaging the implement 106 with the terrain of the worksite. The control system 130 may further direct the implement 106 to move to a predetermined or target position indicative of an automatically determined movement of the implement 106, based in part on, for example, an engineering or site design, a productivity or load maximizing measure, or a combination of site design and productivity measure.

To direct the implement 106 to move precisely in response to an automatically determined movement signal or command, the control system 130 may require certain predetermined measurement data associated with the machine 100 and may need to perform certain predetermined calibrations on other systems and components associated with operating the machine 100. As illustrated in FIGS. 1 and 2, the machine 100 includes a vertical dimension measurement A, a first horizontal dimension measurement B, which is defined within a plane orthogonal to or perpendicular to the plane within which the vertical dimension measurement A is defined, and a second horizontal dimension measurement C (best shown in FIG. 2), which is defined within the same plane as the first horizontal dimension measurement B. It is conceivable and contemplated that the machine 100 may embody other dimension measurements defined in other planes, such as, for example, dimension measurements defined in planes oriented at a predetermined non-orthogonal angle or degree (e.g. a forty-five degree angle) relative to either the horizontal or vertical planes, without departing from the scope of this disclosure.

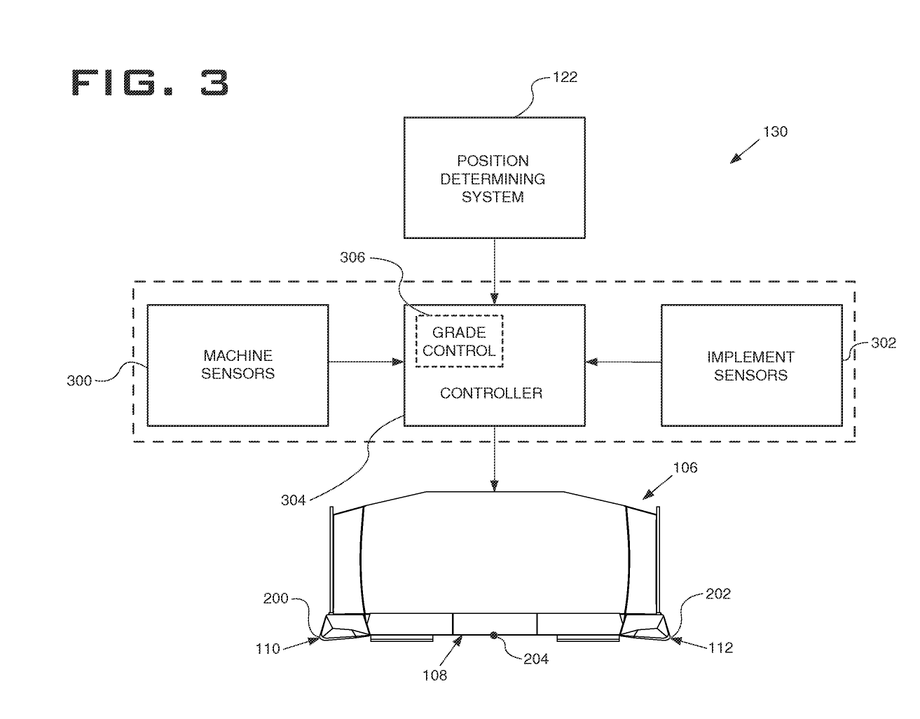

As illustrated in FIG. 3, the implement control system 130 includes at least one sensor 300 operatively connected to or associated with the machine 100, such as, for example, an inclination sensor, at least one sensor 302 operatively connected to or associated with the implement 106, such as, for example, a hydraulic cylinder position sensor, a rotation angle sensor, or a gravitational referenced inclination sensor, and a controller 304. The controller 304 is adapted to receive inputs from the input device, the position determining system 122, and the sensors 300, 302. The implement control system 130 is further adapted to control or direct the movement of the implement 106 based on the inputs from the input device, the position determining system 122, and the sensors 300, 302.

For example, the controller 304 may direct the implement 106 to move to a predetermined or target position in response to an input signal received from a grade control system 306, which may direct the implement 106 to cut to a predetermined or target grade profile. To direct the implement 106 to move precisely in response to an automatically determined movement signal, such as, for example, the grade control system 306 signal, the controller 304 may calibrate the grade control system 306 using the measurements A, B, and C to establish initial machine conditions. The controller 304 may also calibrate the machine sensors 300 and/or the implement sensors 302 using the measurements A, B, and C.

In the illustrated embodiment, the controller 304 is adapted to determine or derive the measurements A, B, and C from the position signals received from the position determining system 122. The controller 304, for example, may be adapted to determine a position of a reference point 132 on the machine 100 in the coordinate system 123. The reference point 132 or reference position may be representative of an absolute position of the GPS receiver 122 mounted to the fixed body 120.

As illustrated in FIG. 2, the controller 304 may be adapted to determine a position of one or more desired points 200, 202 on the cutting edge 108 of the implement 106. The one or more desired positions 200, 202 may be representative of a portion of the implement 106. In the illustrated embodiment, the one or more desired positions 200, 202 are representative of the right edge 110 and the left edge 112 respectively. Alternatively or additionally, in some embodiments, a center point 204 disposed between the right edge 110 and the left edge 112 may represent a desired position.

The controller 304 may be further adapted to determine the measurement A, representative of the vertical dimension of the machine 100, based in part on the reference position 132 and the one or more desired positions 200, 202. The controller 304 may also be adapted to determine the measurement B and/or the measurement C, which are representative of the horizontal dimensions of the machine 100, based in part on the reference position 132 and the one or more desired positions 200, 202. Alternatively, or additionally, the controller 304 may be adapted to determine a measurement (not shown) representative of the distance from the reference position 132 to the one or more desired positions 200, 202. The controller 304 may derive or determine the measurements A, B, and C using known algorithms, such as, for example, vector math, and/or using customized algorithms, for example, customized kinematic equations.

### INDUSTRIAL APPLICABILITY

The industrial applicably of the systems and methods for determining a position on an implement relative to a reference position on the machine described herein will be readily appreciated from the foregoing discussion. Although the machine is shown as track-type tractor, the machine may be any type of machine that performs at least one operation associated with for example mining, construction, and other industrial applications. Moreover, the systems and methods described herein can be adapted to a large variety of machines and tasks. For example, scrapers, backhoe loaders, skid steer loaders, wheel loaders, motor graders, and many other machines can benefit from the systems and methods described.

In accordance with certain embodiments, an implement control system 130 is adapted to determine a reference position 132 on a machine 100 in a coordinate system 123, to determine a first desired position 200 on the machine in the coordinate system 123 and/or a second desired position 202 on the machine, and to determine a first or second relative desired position, in which the first desired position 200 or the second desired position 202 is relative to the reference position 132.

The control system 130 is further adapted to determine a measurement indicative of a vertical dimension A of the machine 100 or a measurement indicative of a horizontal dimension B or C of the machine 100 based in part on the reference position 132, the first relative desired position, or the second relative desired position. The control system 130 is further adapted to be updated using the vertical dimension measurement A or the horizontal dimension measurement B or C. The dimension measurements A, B, or C may be used to calibrate other machine systems, such as, for example, a grade control system 306, and associated sensors, such as, for example, machine sensors 300 and/or implement sensors 302.

Alternatively, or additionally, the dimension measurements A, B, or C may change over time, for example, due to wear on the cutting edge 108 of the implement 106. For example, the first desired position 200 or the second desired position 202 may change relative to the reference position 132 because the right edge 110 or the left edge 112 has changed due to wear. Thus, in some embodiments, the control system 130 is adapted to compare the dimension measurement A, B, or C to a previous dimension measurement and to update the control system 130 based on the comparison.

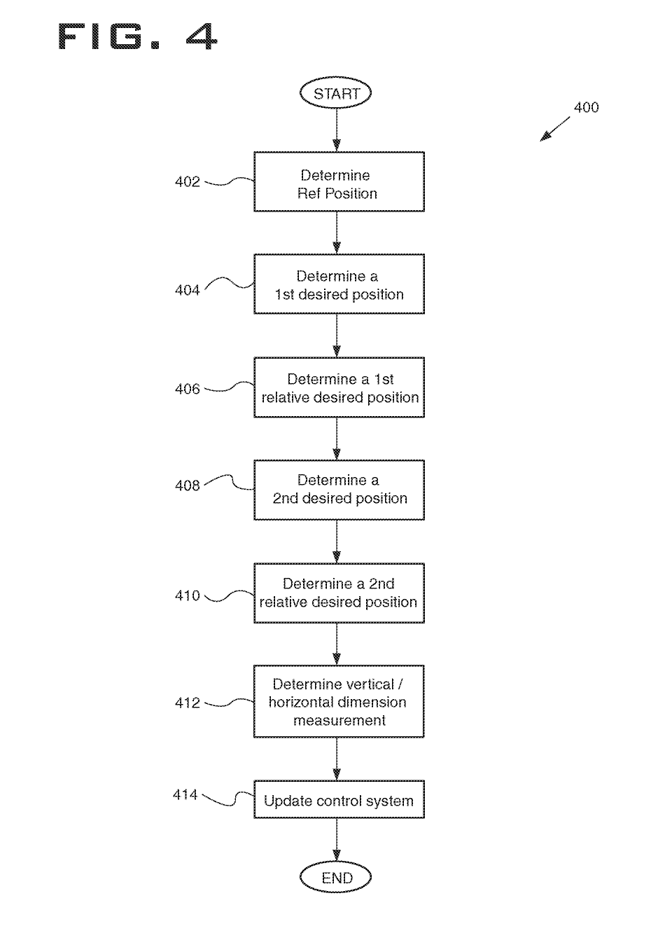

FIG. 4 illustrates an exemplary embodiment of the implement control system 130 and the process of determining the position on the implement 106 relative to the reference position 132 on the machine 100 (400). The controller 304 is adapted to determine the reference position 132 in the coordinate system 123 (Step 402). In some embodiments, the reference position 132 may be associated with a fixed or constant point on the rigid body 120 of the machine 100. The controller 304 may determine the reference position 132 by using the GPS receiver 122. The GPS receiver 122 may be mounted to the rigid body 120 of the machine 100 or may be a mobile receiver placed on the rigid body 120 to receive the position data at the reference point 132 and then removed from the rigid body 120 for receiving position data at a different point or location on the machine 100.

The controller 304 is adapted to determine the first desired position 200 on the machine 100 in the coordinate system 123 (Step 404). The first desired position 200 may represent the first portion of the implement 106, such as, for example, the right edge 110 of the cutting edge 108 of the implement 106. The controller 304 determines the first relative desired position in which the first desired position 200 is relative to the reference position 132 (Step 406).

The controller 304 is further adapted to determine the second desired position 202 on the machine 100 in the coordinate system 123 (Step 408). The second desired position 202 may represent the second portion of the machine 100, such as, for example, the left edge 112 of the cutting edge 108 of the implement 106. The controller 304 determines the second relative desired position in which the second desired position 202 is relative to the reference position 132 (Step 410).

The controller 304 is further adapted to determine the measurement indicative of a vertical dimension A of the machine 100, the measurement indicative of a first horizontal dimension of the machine B, or the measurement indicative of a second horizontal dimension of the machine C (Step 412). Each dimension measurement A, B, and C is based in part on at least one of the reference position 132, the first relative desired position, or the second relative desired position. The controller 304 updates the implement control system 130 using the first desired position 200, the second desired position 202, the first relative desired position, the second relative desired position, the vertical, the first horizontal, and the second horizontal dimension measurements A, B, and C.

Alternatively, or additionally, the controller 304 compares at least one of the first relative desired position to a previous first relative desired position or the second relative desired position to a previous second relative desired position and updates the at least one of the first relative desired position or the second relative desired position as a function of the comparison. In addition, the controller 304 may compare at least one of the dimension measurements A, B, and C to a previous dimension measurement and may update the implement control system 130 based in part on the comparison.

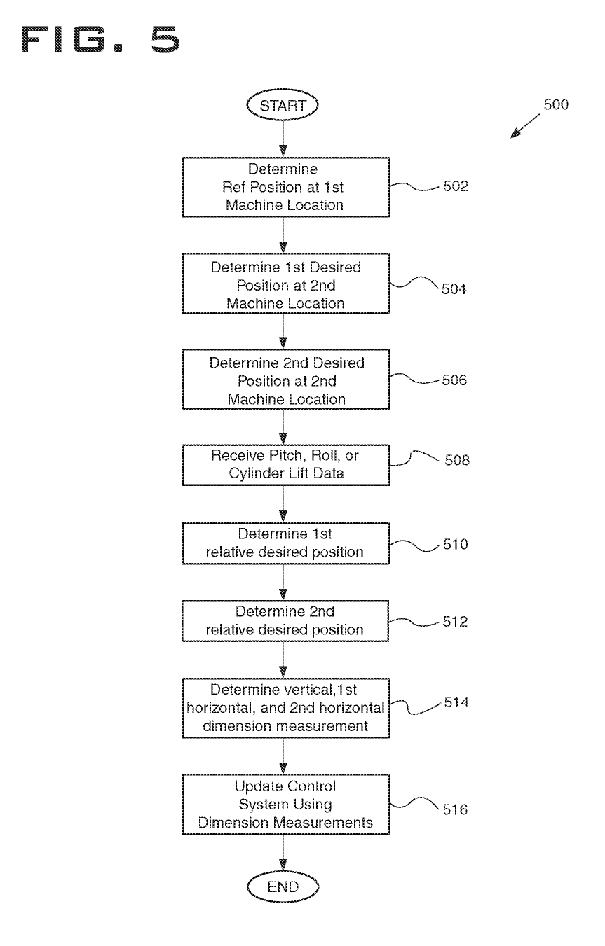

FIG. 5 illustrates an alternative exemplary embodiment of the implement control system 130 and the process of determining the position on the implement 106 relative to the reference position 132 on the machine 100 (500). The controller 304 is adapted to determine the reference position 132 on the rigid body 120 of the machine 100 when the machine 100 is at a first machine location (Step 502). The controller 304 is further adapted to determine a first desired position 200 when the machine 100 is at a second machine location (Step 504), wherein the first desired position 200 is representative of the right edge 110 of the implement 106 operatively connected to the rigid body 120 of the machine 100.

In the illustrated embodiment, the controller 304 further determines a second desired position 202 when the machine 100 is at the second machine location (Step 506), wherein the second desired position 202 is representative of the second edge 112 of the implement 106. In some embodiments, to determine the first desired position 200 or the second desired position 202 when the machine 100 is at the second machine location, the first desired position 200 or the second desired position is marked, such as, for example, using a stake in the ground and the machine 100 is moved from the first machine location to the second machine location. Moving the machine 100 from the first location to the second location helps resolve accuracy issues associated with multipath error and signal degredation, which as is well known may occur when you have, for example, the GPS receiver 122 too close to metal objects (e.g. the machine) or tall objects that interfere with the signal transmission between the receiver and the satellites.

The controller 304 is further adapted to receive a signal from the sensor 300 operatively connected to the machine 100, such as, for example, the inclination sensor, wherein the signal may be indicative of at least one of pitch or roll data, and a signal from the sensor 302 operatively connected to the implement 106, such as, for example, the hydraulic cylinder position sensor, wherein the signal may be indicative of cylinder data (Step 508).

The controller 304 is further adapted to determine the first relative desired position in which the first desired position 200 is relative to the reference position 132 (Step 510) and the second relative desired position in which the second desired position 202 is relative to the reference position 132 (Step 512). The controller 304 determines the measurement indicative of a vertical dimension A of the machine 100, the measurement indicative of a first horizontal dimension B of the machine 100, and the measurement indicative of a second horizontal dimension C of the machine 100 (Step 514). Each of the vertical, the first horizontal, and the second horizontal dimension measurements A, B, and C is based in part on at least one of the reference position 132, the first relative desired position, the second relative desired position, the pitch signal, the roll signal, or the hydraulic cylinder data signal.

The controller 304 updates the implement control system 130 using the first and second relative desired positions, and the vertical, the first horizontal, and the second horizontal dimension measurements A, B, and C (Step 516). Alternatively, or additionally, the controller 304 compares at least one of the first relative desired position to a previous first relative desired position or the second relative desired position to a previous second relative desired position and updates the at least one of the first relative desired position or the second relative desired position as a function of the comparison. In addition, the controller 304 may compare at least one of the dimension measurements A, B, and C to a previous dimension measurement and may update the implement control system 130 based in part on the comparison.

The implement control system 130, the controller 304, and the grade control system 306 may include one or more control modules (e.g. ECMs, ECUs, etc.). The one or more control modules may include processing units, memory, sensor interfaces, and/or control signal interfaces (for receiving and transmitting signals). The processing units may represent one or more logic and/or processing components used by the implement control system 130 to perform certain communications, control, and/or diagnostic functions. For example, the processing units may be adapted to execute routing information among devices within and/or external to the implement control system 130.

Further, the processing units may be adapted to execute instructions, including from a storage device, such as memory. The one or more control modules may include a plurality of processing units, such as one or more general purpose processing units and or special purpose units (for example, ASICS, FPGAs, etc.). In certain embodiments, functionality of the processing unit may be embodied within an integrated microprocessor or microcontroller, including integrated CPU, memory, and one or more peripherals. The memory may represent one or more known systems capable of storing information, including, but not limited to, a random access memory (RAM), a read-only memory (ROM), magnetic and optical storage devices, disks, programmable, erasable components such as erasable programmable read-only memory (EPROM, EEPROM, etc.), and nonvolatile memory such as flash memory.

It will be appreciated that the foregoing description provides examples of the disclosed systems and methods. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A method for determining a position on a machine relative to a reference position on the machine, the method comprising:
determining the reference position in a coordinate system;
determining a first desired position on the machine in the coordinate system,
determining a first relative desired position wherein the first desired position is relative to the reference position, and
updating a control system using the first relative desired position.

2. The method of claim 1, the method further comprising:
determining a second desired position on the machine in the coordinate system;
determining a second relative desired position wherein the second desired position is relative to the reference position; and
updating the control system using the second relative desired position.

3. The method of claim 1, wherein determining the first desired position includes determining the first desired position of a first portion of an implement operatively connected to a rigid body of the machine.

4. The method of claim 3, wherein determining the first desired position of the first portion includes determining the first desired position of a first edge of the implement.

5. The method of claim 2, wherein determining the second desired position on the machine includes determining the second desired position of a second portion of an implement operatively connected to a rigid body of the machine.

6. The method of claim 5, wherein determining the second desired position of the second portion of the implement includes determining the second desired position of a second edge of the implement.

7. The method of claim 2, the method further comprising:
determining at least one of a measurement indicative of a vertical dimension of the machine or a measurement indicative of a horizontal dimension of the machine, wherein the at least one of a vertical dimension measurement or a horizontal dimension measurement is based in part on at least one of the reference position, the first relative desired position, or the second relative desired position; and
updating the control system using the at least one of a vertical dimension measurement or a horizontal dimension measurement.

8. The method of claim 2, the method further comprising:
determining a measurement indicative of a vertical dimension of the machine, a measurement indicative of a first horizontal dimension of the machine, and a measurement indicative of a second horizontal dimension of the machine, wherein each of the vertical, the first horizontal, and the second horizontal dimension measurements is based in part on at least one of the reference position, the first relative desired position, or the second relative desired position; and
updating the control system using the vertical, the first horizontal, and the second horizontal dimension measurements.

9. The method of claim 8, the method further comprising:
receiving a signal from a sensor operatively connected to a rigid body of the machine, the signal is indicative of at least one of pitch or roll data; and
wherein determining the first relative desired position or the second relative desired position is based in part on the at least one of pitch or roll data signal.

10. The method of claim 9, the method further comprising:
receiving a signal from a sensor operatively connected to the implement, the signal is indicative of hydraulic cylinder data; and
wherein determining the first relative desired position or the second relative desired position is based in part on at least one of pitch, roll, or hydraulic cylinder data signal.

11. The method of claim 10, wherein determining the reference position includes determining a reference position on the rigid body of the machine, wherein determining at least one of the reference position, the first desired position, or the second desired position includes using a plurality of GPS receivers, and wherein determining the reference position includes using one GPS receiver from the plurality of GPS receivers mounted to the rigid body of the machine.

12. The method of claim 11, wherein determining the reference position on the rigid body of the machine includes determining the reference position when the machine is at a first machine location; and
wherein determining the first desired position or determining the second desired position includes determining the first or second desired position when the machine is at a second machine location.

13. The method of claim 2, the method further comprising:
comparing at least one of the first relative desired position to a previous first relative desired position or the second relative desired position to a previous second relative desired position; and
updating the at least one of the first relative desired position or the second relative desired position as a function of the comparison.

14. An implement control system disposed in a machine for determining a position on the machine relative to a reference position on the machine having an implement operatively connected to a rigid body of the machine, comprising:
a controller operatively connected to the implement, the controller adapted to:
determine the reference position in a coordinate system;
determine a first desired position on the implement in the coordinate system;
determine a first relative desired position wherein the first desired position is relative to the reference position; and
update the implement control system using the first relative desired position.

15. The implement control system of claim 14, wherein the controller is further adapted to:
determine a second desired position on the implement in the coordinate system; and
determine a second relative desired position wherein the second desired position is relative to the reference position, and
update the implement control system using the second relative desired position.

16. The implement control system of claim 15, wherein the controller is further adapted to:
determine a measurement indicative of a vertical dimension of the machine, a measurement indicative of a first horizontal dimension of the machine, and a measurement indicative of a second horizontal dimension of the machine, wherein each of the vertical, the first horizontal, and the second horizontal dimension measurements is based in part on at least one of the reference position, the first relative desired position, or the second relative desired position; and
update the implement control system using the vertical, the first horizontal, and the second horizontal dimension measurements.

17. The implement control system of claim 16, wherein determining the reference position includes determining a reference position on the rigid body of the machine, and wherein determining the first desired position includes determining a first edge of the implement and determining the second desired position includes determining a second edge of the implement.

18. The implement control system of claim 17, further including a plurality of GPS receivers, wherein determining the reference position includes using one GPS receiver from the plurality of GPS receivers mounted to the rigid body of the machine.

19. The implement control system of claim 15, wherein the controller is further adapted to:
compare at least one of the first relative desired position to a previous first relative desired position or the second relative desired position to a previous second relative desired position; and
update the at least one of the first relative desired position or the second relative desired position as a function of the comparison.

20. A method for determining a position on a machine relative to a reference position on the machine, the method comprising:
determining the reference position on a rigid body of the machine when the machine is at a first machine location;
determining a first desired position when the machine is at a second machine location, wherein the first desired position is representative of a first edge of an implement operatively connected to the rigid body of the machine;
determining a second desired position when the machine is at the second machine location, wherein the second desired position is representative of a second edge of the implement;
receiving a signal from sensor operatively connected to the machine, wherein the signal is indicative of at least one of pitch, roll, or hydraulic cylinder data;
determining a first relative desired position wherein the first desired position is relative to the reference position;
determining a second relative desired position wherein the second desired position is relative to the reference position;
determining a measurement indicative of a vertical dimension of the machine, a measurement indicative of a first horizontal dimension of the machine, and a measurement indicative of a second horizontal dimension of the machine, wherein each of the vertical, the first horizontal, and the second horizontal dimension measurements is based in part on at least one of the reference position, the first relative desired position, the second relative desired position, the pitch signal, the roll signal, or the hydraulic cylinder data signal; and
updating an implement control system using the first and second relative desired positions, and the vertical, the first horizontal, and the second horizontal dimension measurements.
